(19) United States
(12) Patent Application Publication
(10) Pub. No.: US 2008/0158512 A1
(43) Pub. Date: Jul. 3, 2008

(54) Two-Dimensional Image Formation Device

(76) Inventors: Tetsuro Mizushima, Osaka (JP); Kenichi Kasazumi, Osaka (JP); Tomoya Sugita, Osaka (JP); Kazuhisa Yamamoto, Osaka (JP)

Correspondence Address: STEPTOE & JOHNSON LLP, 1330 CONNECTICUT AVE., NW, WASHINGTON, DC, 20036, US

(21) Appl. No.: 11/884,751

(22) PCT Filed: Feb. 24, 2006
(86) PCT No.: PCT/JP2006/303482

§ 371 Date: Aug. 21, 2007

(30) Foreign Application Priority Data
Feb. 25, 2005 (JP) 2005-050415

(51) Int. Cl. G03B 21/14; G02B 5/30

(52) U.S. Cl. 353/20

(57) ABSTRACT

A two-dimensional image formation device of the present invention is provided with a spatial light modulation element (7) for modulating light having a linear polarization and emitted from a laser light source (1), and a depolarization means (21) for depolarizing the modulated light before it is incident on an image display surface. The light having a linear polarization is used before and after incidence of irradiated light to the spatial light modulation element (7), and the linear polarization of the irradiated light is depolarized after the modulation, whereby randomly polarized light is projected on a screen (11). Thereby, speckle noise is significantly reduced, and a high-definition image can be formed.

### TECHNICAL FIELD

The present invention relates to a two-dimensional image formation device such as a television receiver, a video projector, or the like.

### BACKGROUND ART

As a two-dimensional image formation device, a projection display which projects an image on a screen has been widespread. A lamp light source is used for such projection display. However, the lamp light source has a short life, a restricted color reproduction area, and a low light use efficiency.

In order to solve these problems, it is attempted to use a laser light source as a light source for the image formation device. Since the laser light source has a longer life relative to the lamp light source and a high directionality, its light use efficiency can be easily increased. Further, since the laser light source shows a monochromaticity, it has a large color reproduction area, and enables display of a bright image.

A schematic diagram of a proposed laser light source projection display is shown in FIG. 6.

A conventional two-dimensional image formation device 200 shown in FIG. 6 projects a two-dimensional image on a screen 11, and it includes laser light sources 1a to 1c of three colors R, G, and B, beam expanders 2a to 2c, light deflection means 4a to 4c, light integrators 3a to 3c, condenser lenses 9a to 9c, mirrors 5a and 5c, field lenses 6a to 6c, spatial light modulation elements 7a to 7c, a dichroic prism 8, and a projection lens 10.

The beam expander 2a, the light deflection means 4a, the light integrator 3a, the condenser lens 9a, the mirror 5a, the field lens 6a, and the spatial light modulation element 7a constitute a red optical system which guides a laser light emitted from the red laser light source 1a to the dichroic prism 8, and these optical members are successively disposed along the path of the laser beam traveling from the laser light source la toward the dichroic prism 8.

The beam expander 2a expands the light emitted from the laser light source 1a and guides the light to the light integrator 3a. The light integrator 3a is constituted such that a pair of lens arrays each comprising rectangular unit lenses arranged in matrix are opposed, and it converts a light beam having a light intensity distribution into a rectangular light beam having an approximately uniform intensity. The light deflection means 4a disposed between the beam expander 2a and the light integrator 3a vibrates the optical elements for deflecting the light to change the angle of the light that is incident on the light integrator 3a from the beam expander 2a.

The beam expander 2b, the light deflection means 4b, the light integrator 3b, the condenser lens 9b, the field lens 6b, and the spatial light modulation element 7b constitute a green optical system which guides a laser beam emitted from the green laser light source 1bto the dichroic prism 8. The beam expander 2c, the light deflection means 4c, the light integrator 3c, the condenser lens 9c, the mirror 5c, the field lens 6c, and the spatial light modulation element 7c constitute a blue optical system which guides a laser beam emitted from the blue laser light source 1c to the dichroic prism 8. The respective optical members of these optical systems are identical to the optical members constituting the above-mentioned red optical system.

The dichroic prism 8 multiplexes the lights that have passed through the spatial light modulation elements 7a to 7c, and the projection lens 10 projects the light multiplexed by the dichroic prism 8 on the screen 11 as a full-color image.

In the two-dimensional image formation device 200 constituted as described above, the lights emitted from the R, G, B laser light sources 1a to 1c are expanded by the beam expanders 2a to 2c, and irradiate the spatial light modulation elements 7a to 7c through the light deflection means 4a to 4c and the light integrators 3a to 3c, respectively. In the light integrators 3a to 3c, the light beams each having a light intensity distribution showing an approximate Gaussian distribution are converted so as to be approximately uniform rectangular light beams on the spatial light modulation elements 7a to 7c, and the light beams converted by the light integrators 3a to 3c irradiate the spatial light modulation elements 7a to 7c with uniform intensities, respectively.

The light beams that have passed through the spatial light modulation elements 7a to 7c are multiplexed by the dichroic prism 8, and are projected on the screen 11 as a full-color image by the projection lens 10.

By the way, a display using a laser light source has a problem of speckle noise that is caused by high coherency of laser. The speckle noise is minute uneven noise that is caused by interference of scattered lights when the laser light is scattered on the screen 11.

In order to suppress such speckle noise, for example, there is proposed a method of varying the pattern of speckle noise to temporarily average the same using a dynamic mechanism for vibrating the optical elements, such as the light deflection means 4a to 4c shown in FIG. 6.

Furthermore, in order to reduce such speckle noise, there is also proposed a method for reducing interference of scattered lights between adjacent pixels in the spatial light modulation element by using a means for giving a polarization distribution so as to make the polarization directions of lights incident on the adjacent pixels in the spatial light modulation elements different from each other.

Patent Document 1: Japanese Published Patent Application No. 2002-62582

Patent Document 2: Japanese Published Patent Application No. Hei. 10-293268

### DISCLOSURE OF THE INVENTION

### Problems to be Solved by the Invention

However, it can hardly be said that the conventional methods for reducing the speckle noise that occurs in the display (two-dimensional image formation device) using the laser light source as described above can sufficiently reduce the noise, and therefore, a method for further reducing the speckle noise is required.

Further, when the polarization distribution is given to the light before it is incident on the spatial light modulation element, it becomes difficult to control the light.

The present invention is made to solve the above-described problems and has for its object to provide a two-dimensional image formation device that can achieve further reduction in speckle noise, thereby forming a high-definition image.

### MEASURES TO SOLVE THE PROBLEMS

In order to solve the above-mentioned problems, according to Claim 1 of the present invention, there is provided a two-dimensional image formation device having a laser light source and a modulation means for modulating a light emitted from the laser light source, wherein the light modulated by the modulation means has a linear polarization property, and a depolarization means for depolarizing the linear polarization property of the light modulated by the modulation means is provided.

Therefore, the linear polarization property of the light modulated by the modulation means is depolarized, and a light having a linear polarization property can be used as the light before and after incidence on the modulation means, and further, a light having no linear polarization property can be projected onto an image display plane, thereby reducing speckle noise that occurs on the image display plane.

Further, according to Claim 2 of the present invention, the two-dimensional image formation device defined in Claim 1 further includes a projection unit for projecting the modulated light onto an image display plane, and the depolarization means is incorporated in the projection unit.

Therefore, the depolarization means is located in a position different from an image formation plane, and the light projected onto the image display plane is in a randomly polarized state wherein lights of various polarization states are mixed, even within one pixel that forms an image on the image display plane, thereby realizing a reduction in speckle noise within one pixel.

Further, according to Claim 3 of the present invention, in the two-dimensional image formation device defined in Claim 1 or 2, the depolarization means includes a birefringent member comprising a birefringent material which is formed in a plate shape and has a thickness distribution, and the light having a linear polarization property, which is modulated by the modulation means and outputted, is incident on the birefringent member with its polarization direction being inclined with respect to an optical axis of the birefringent member.

Therefore, a light in a randomly polarized state is projected onto the image display plane, thereby reducing speckle noise that occurs on the image display plane.

Further, according to Claim 4 of the present invention, in the two-dimensional image formation device defined in Claim 3, the depolarization means comprises an optical element which is obtained by placing the birefringent member upon a plate-shaped thickness compensation member having a thickness distribution which compensates the thickness distribution of the birefringent member; and the light having a linear polarization property, which is modulated by the modulation means and outputted, is incident on the optical element with its polarization direction being inclined with respect to the optical axis of the birefringent member.

Therefore, the light passing through the depolarization means is prevented from bending.

Further, according to Claim 5 of the present invention, in the two-dimensional image formation device defined in Claim 1 or 2 wherein the birefringent property of the birefringent member has an in-plane distribution.

Therefore, a light in a randomly polarized state is projected onto the image display plane, thereby reducing speckle noise that occurs on the image display plane.

Further, according to Claim 6 of the present invention, the two-dimensional image formation device defined in any of Claims 1 to 5 further includes a deflection means for varying the angle of the light incident on the modulation means, which is disposed in a stage prior to the modulation means.

Therefore, the angle of the light projected onto the image display plane varies with time, and the pattern of speckle noise that occurs on the image display plane varies and thereby the noise is averaged, resulting in a further reduction in the speckle noise.

Further, according to Claim 7 of the present invention, the two-dimensional image formation device defined in any of Claims 1 to 6 further includes a light conversion means for converting a light in a randomly polarized state which is emitted from the light source into a light having a linear polarization property, which light conversion means is disposed in a stage prior to the modulation means.

Therefore, even when the light emitted from the light source is in a randomly polarized state, the light converted into a linearly polarized state can be incident on the modulation means.

### EFFECTS OF THE INVENTION

The two-dimensional image formation device according to the present invention is provided with the depolarization means for, after a linearly polarized light emitted from the laser light source is modulated by the modulation means, converting the modulated light into a randomly polarized light when it is incident on the image display plane, and a light having a linear polarization property is used as the light before and after incidence on the modulation means. After the modulation, the linear polarization property of the incident light is depolarized to project a randomly polarized light onto the image display plane, thereby significantly reducing speckle noise that occurs on the screen.

Further, in the two-dimensional image formation device according to the present invention, since the depolarization means is incorporated in a position different from the image formation plane, the light projected onto the image display plane is in a randomly polarized state in which lights of various polarization states are mixed, even within one pixel that forms an image on the image display plane, thereby reducing speckle noise within one pixel.

### BRIEF DESCRIPTION OF THE DRAWINGS

FIG. 1 is a diagram illustrating a two-dimensional image formation device 100 according to a first embodiment of the present invention, wherein FIG. 1(a) shows a schematic construction thereof, and FIG. 1(b) shows appropriate positions of optical members in the device.

FIG. 2 is a diagram illustrating a construction of a depolarization means in the two-dimensional image formation device according to the first embodiment.

FIG. 3 is a diagram illustrating a construction of a rotation lenticular lens in the two-dimensional image formation device according to the first embodiment.

FIG. 4 is a diagram illustrating a construction of a depolarization means 23 in a two-dimensional image formation device 200 according to a second embodiment of the present invention.

FIG. 5 is a diagram illustrating a construction of a red laser light source in a two-dimensional image formation device 300 according to a third embodiment of the present invention.

FIG. 6 is a schematic block diagram illustrating a conventional two-dimensional image formation device.

### DESCRIPTION OF THE REFERENCE NUMERALS

1 . . . laser light source

1a,1a0 . . . red laser light source

1a1 . . . LD chip array

1a2 . . . optical fiber

1a3 . . . multimode fiber

1a4 . . . polarization conversion element

1a5 . . . polarization beam splitter

1a6 . . . ½ wavelength plate

1b. . . green laser light source

1c. . . blue laser light source

2a˜2c. . . beam expander

3a˜3c. . . optical integrator

4a˜4c. . . light deflection means

5a,5c. . . mirror

6a˜16c. . . field lens

7a˜7c. . . spatial light modulation element

8 . . . dichroic prism

9a˜9c. . . condenser lens

10 . . .projection lens

11 . . . screen

13a˜13c. . . rod integrator

14,14a˜14c. . . rotation lenticular lens

15,16 . . . lenticular lens plate

19a˜19c. . . projection optical system

20 . . . projection unit

21 . . . depolarization means (depolarization element)

21a. . . birefringent member

21b. . . thickness compensation member

23 . . . depolarization means (depolarization element)

23a. . . region where abnormal refractive index is not changed

23b. . . region where abnormal refractive index is changed

### BEST MODE TO EXECUTE THE INVENTION

Hereinafter, embodiments of the present invention will be described with reference to the drawings.

### EMBODIMENT 1

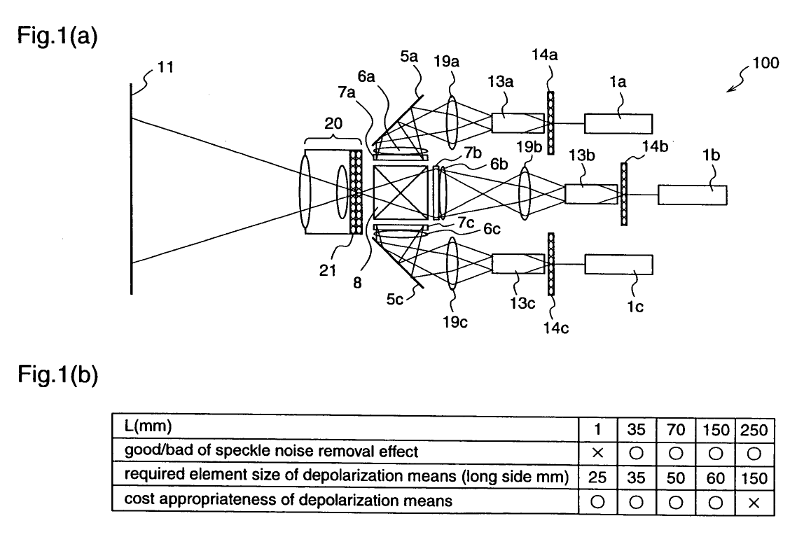

FIG. 1 illustrates a two-dimensional image formation device according to a first embodiment of the present invention, wherein FIG. 1(a) is a schematic block diagram thereof, and FIG. 1(b) is a diagram illustrating appropriate positions of optical elements in the two-dimensional image formation device.

The two-dimensional image formation device 100 according to the first embodiment is, for example, a front projection type display using a laser light source, and forms a two-dimensional image on a screen 11. This two-dimensional image formation device 100 comprises a red laser light source 1a, a green laser light source 1b, a blue laser light source 1c, rotation lenticular lenses 14a to 14c, rod integrators 13a to 13c, projection optical systems 19a to 19c, mirrors 5a and 5c, field lenses 6a to 6c, spatial light modulation elements 7a to 7c, a dichroic prism 8, and a projection unit 20.

The light sources 1a to 1c, the mirrors 5a and 5c, the field lenses 6a to 6c, the spatial light modulation elements 7a to 7c, and the dichroic prism 8 are identical to those of the conventional two-dimensional image formation device 200.

The laser light sources 1a to 1c may be implemented by gas lasers such as a He—Ne laser, a He—Cd laser, and a Ar laser, semiconductor lasers such as a AlGaInP laser and a GaN laser, and a SHG laser with a solid laser or a fiber laser being a fundamental wave.

Further, the spatial light modulation elements 7a to 7c can be implemented by elements such as liquid crystal elements utilizing polarization directions or mirror elements utilizing deflection and diffraction directions, and modulations of both elements are facilitated by inputting light having a linear polarization property to the elements to make the modulated light have a linear polarization property.

In this first embodiment, since liquid crystal elements utilizing polarization directions are adopted for the spatial light modulation elements 7a to 7c. Further, since the modulation performed in the liquid crystal element utilizes a linear polarization property, the light incident to the liquid crystal element has a linear polarization property.

The rod integrators 13a to 13c are rectangular parallelepiped optical elements, and the lights incident on the rod integrators repeat reflections inside and are emitted from emission facets, respectively. The projection optical systems 19a to 19c project the lights emitted from the rod integrators 13a to 13c onto the spatial light modulation elements 7a to 7c, respectively.

The projection unit 20 is disposed between the spatial light modulation elements 7a˜7c and the screen 11, and it projects the two-dimensional image that is modulated by the spatial light modulation elements onto the screen 11 so that a viewer can see the image. The projection unit 20 according to the first embodiment includes a depolarization means 21 for depolarizing the linear polarization properties of the lights modulated by the spatial light modulation elements 7a to 7c.

Further, the projection unit 20 includes a projection lens group for enlarging and focusing a two-dimensional image on the screen 11. When incorporating the depolarization means 21 in the projection unit 20, it may be disposed on the incident side or the emission side of the projection lens group, or it may be inserted in the projection lens group. The insertion position of the depolarization means 21 is desired to satisfy a relationship of F/#<L<5f, assuming that the distance (mm) between the spatial light modulation element and the depolarization means is L, the F number of the projection unit is F/#, and the focal distance (mm) on the spatial light modulation element side of the projection unit is f. When the depolarization means 21 satisfies the above-mentioned condition, the light incident on the image display plane can be placed in the random polarization state which is enough to remove speckle noise within one pixel that forms an image on the image display plane, and the depolarization means 21 can be fabricated with efficiency without increasing the size thereof more than necessary.

FIG. 1(b) is a diagram illustrating the relationships among the distance L between the spatial light modulation element 7 and the depolarization means 21, the degree of the speckle noise removal effect, the size of the depolarization means 21, and the appropriateness of the cost of the depolarization means 21.

When the L is shorter than the F/#, sufficient random polarization state of the incident light within one pixel on the image display plane cannot be realized, and thereby removal of the speckle noise is insufficient. On the other hand, when the L is larger than 5f, it is necessary to use a large depolarization means for removing the speckle noise on the entire display plane, leading to disadvantage in cost and difficulty in miniaturizing the device.

Accordingly, in this first embodiment, in order to realize both the sufficient effect of removing the speckle noise within one pixel and the miniaturization of the depolarization means 21, the distance L is set to 35 mm, the F number F/# is set to 1.7, the focal distance f is set to 40.7 mm, and the depolarization means 21 is inserted on the incident side of the projection lens group.

Further, a member having a birefringence property with a thickness distribution is used for the depolarization means 21. When a linearly polarized light is incident on the member having a birefringence property with a thickness distribution, with the polarization direction of the light being inclined with respective to the optical axis of the member, the member emits lights having various polarization properties.

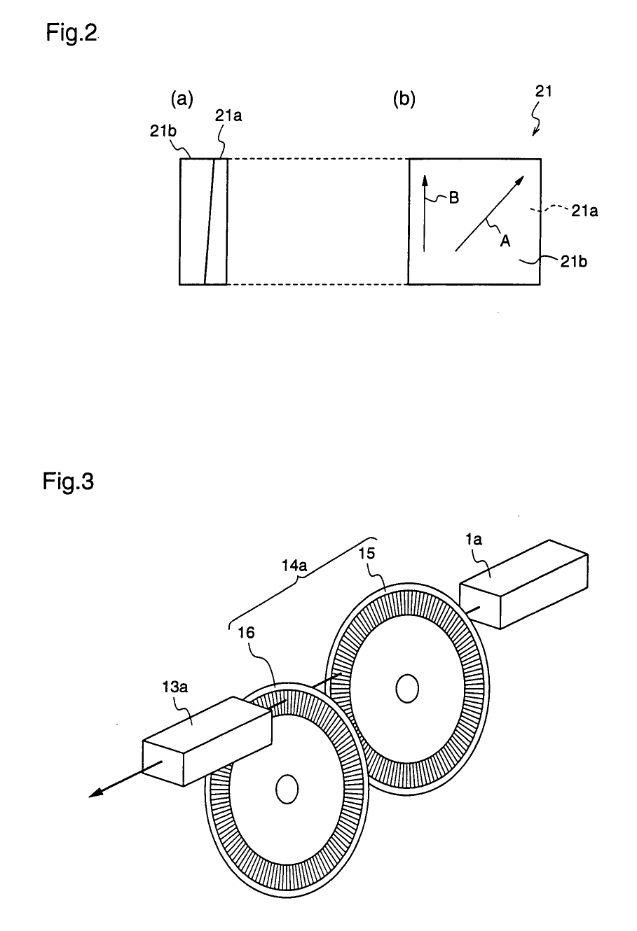

FIG. 2 is a diagram illustrating the depolarization means (depolarization element) 21 according to the first embodiment. FIG. 2(a) is a cross-sectional view thereof, wherein a light beam passes from right to left on the space. FIG. 2(b) is a front view thereof, wherein a light beam passes from behind to front in the space.

This depolarization means 21 comprises a birefringent member 21a that has a birefringence property having a thickness distribution, and a thickness compensation member 21b that compensates the thickness distribution. These members are bonded to each other with UV resin or the like.

The birefringent member 21a comprises an optical crystal that is a material having a birefringence property, and its thickness distribution has a constant inclination. This member 21a is arranged so that its optical axis A is in a direction inclined with respect to the polarization direction of the modulated light, for example, the optical axis A is in a direction inclined at 45° from the horizontal direction with respect to the vertical or horizontal linear polarization direction.

Further, the thickness compensation member 21b comprises an optical crystal, and has a thickness distribution that compensates the thickness distribution of the member 21a. This member 21b is arranged adjoining to the member 21a so that its optical axis B is in a direction different from the optical axis of the member 21a, for example, the optical axis B is in the same direction as the linear polarization direction of the modulated light. While the member 21b is formed on the member 21a so as to compensate the thickness distribution of the member 21a as described above, the member 21b is not necessarily composed of the same material as the member 21a, and further, the member 21b may be formed of a material having no birefringence property. The point is that the member 21b has a refractive index that is approximately equal to that of the member 21a, and has a thickness distribution that compensates the thickness distribution of the member 21a.

In the depolarization means 21 constituted as described above, since the thickness of the birefringent member 21a varies depending on the position where the light having a linear polarization property is incident on the birefringent member 21a, the light that has passed through the depolarization element 21 becomes to have different polarization properties depending on the thicknesses of the member 21a where the light has passed, and the lights having the different polarization properties are mixed on the screen 11 to be in the randomly polarized state.

Even when one of the two members 21a and 21b of the depolarization means 21 is placed on the light beam incident side, the same function as mentioned above can be achieved.

FIG. 3 is a diagram illustrating the rotation lenticular lens 14a of the red optical system according to the first embodiment.

The rotation lenticular lens 14a comprises two rotatable lenticular lens plates 15 and 16. Each of the lenticular lens plates 15 and 16 is obtained by arranging plural lenses each having a trapezoidal plane view and an arch-shaped sectional view so that the lenses are adjacent to each other on a circle having a predetermined radius, and the longitudinal direction of each lens faces the center of the circle, whereby the light incident on the lenses arranged on the circle is deflected and emitted. The lenticular lens plate 15 is arranged so as to change the deflection direction of the light emitted from the light source to the vertical direction, while the lenticular lens plate 16 is arranged so as to change the deflection direction of the light emitted from the light source to the horizontal direction. The rotation lenticular lens 14b of the green optical system and the rotation lenticular lens 14c of the blue optical system have the same construction as that of the rotation lenticular lens 14a of the red optical system.

Next, the operation and the functional effect of the first embodiment will be described.

When the light emitted from the red laser light source 1a is incident on the rotation lenticular lens 14a, initially, it is deflected in the vertical direction by the lenticular lens plate 15 and, thereafter, deflected in the horizontal direction by the lenticular lens plate 16. As a result, the light whose deflection direction continuously changes vertically and horizontally is introduced to the rod integrator 13a from the rotation lenticular lens 14a.

The light guided to the rod integrator 13a repeats internal reflection in the rod integrator 13a and reaches the emission end, and the light that has reached the emission end passes through the projection optical system 19a, the mirror 5a, and the field lens 6a to be projected onto the spatial light modulation element 7a as a rectangle light beam having a uniform light intensity distribution.

In the spatial light modulation element 7a, the light emitted from the red laser light source is modulated to a two-dimensional image, and the modulated red light is introduced into the dichroic prism 8.

Like the light emitted from the red laser light source, the green laser light emitted from the green laser light source 1b is also projected onto the spatial light modulation element 7b through the rotation lenticular lens 14b, the rod integrator 13b, the projection optical system 19b, and the field lens 6b, and then it is modulated to a two-dimensional image by the spatial light modulation element 7b, and the modulated green laser light is introduced to the dichroic prism 8.

Further, like the light emitted from the red laser light source, the blue laser light emitted from the blue laser light source 1c is also projected onto the spatial light modulation element 7c through the rotation lenticular lens 14c, the rod integrator 13c, the projection optical system 19c, the mirror 5c, and the field lens 6c, and then it is modulated to a two-dimensional image by the spatial light modulation element 7c, and the modulated blue laser light is introduced to the dichroic prism 8.

Then, in the dichroic prism 8, the lights modulated by the respective spatial light modulation elements are multiplexed and then projected onto the screen 11 as a full-color two-dimensional image by the projection unit 20.

At this time, the linear polarization properties of the lights that are spatially modulated by the respective spatial light modulation elements 7a to 7c are depolarized by the depolarization means 21 in the projection unit 20, and thereby the light in the randomly polarized state is projected onto the screen.

The randomly polarized state is a state where the electric vector of the light wave has various directions of oscillation components within the plane perpendicular to the advancing direction of the light wave, while the state having a linear polarization property is a state where the electric vector of the light wave is in the harmonically oscillated state in a constant direction and the oscillation component in the direction perpendicular to the constant direction is extremely small, and furthermore, the lights whose polarization directions are perpendicular to each other do not interfere with each other. Therefore, when the light in such randomly polarized state is projected onto the screen 11, the coherency of the projected light that is scattered on the screen is reduced, leading to a reduction in the speckle noise. Further, since the angle of the light projected on the screen 11 varies, a plurality of different speckle patterns occur even in the same position on the screen, and consequently, the speckle patterns are diversified, leading to a reduction in the speckle noise intensity.

As described above, in the two-dimensional image formation device according to the first embodiment, the linearly polarized light emitted from the laser light source is modulated by the spatial light modulation elements and then converted into the randomly polarized light by the depolarization means 21, whereby speckle noise that appears on the screen can be significantly reduced without applying burden on the device.

Further, in this first embodiment, since the depolarization means 21 is inserted in a position distant from the imaging surface of the two-dimensional image formed on the screen 11, the light projected on the screen can be randomly polarized even within one pixel of the two-dimensional image, and thereby speckle noise within one pixel can also be reduced.

Further, since the depolarization means is constituted by combining the plate-shaped birefringent member that has a birefringence property having a thickness distribution and the plate-shaped thickness compensation member that compensates the thickness distribution, the light transmitted through the depolarization means is prevented from bending. Further, the depolarization means is constituted such that the thickness distributions of the two members 21a and 21b constituting the depolarization means have constant inclinations, respectively, thereby facilitating fabrication of the depolarization means.

Furthermore, in this first embodiment, after the linearly polarized light emitted from the laser light source is modulated by the spatial modulation element, the modulated light is randomly polarized by the depolarization means 21, and moreover, the angle of the light incident on the spatial light modulation element is previously varied by the rotation lenticular lens, whereby speckle noise can be further reduced to a level that cannot be recognized by viewers.

While in this first embodiment the depolarization means 21 has a birefringent property having a thickness distribution, the depolarization means 21 is not restricted to that of the first embodiment.

### EMBODIMENT 2

A two-dimensional image formation device according to a second embodiment of the present invention adopts a depolarization means 23 which has a birefringent property having an in-plane distribution, instead of the depolarization means 211 of the two-dimensional image formation device according to the first embodiment.

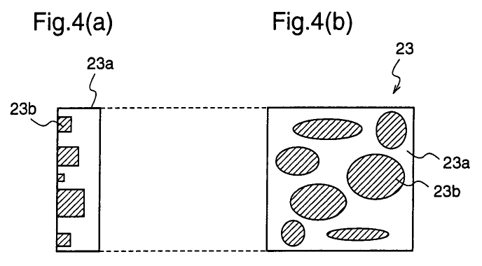

FIG. 4 illustrates a depolarization means (depolarization element) 23 that has a birefringent property having an in-plane distribution, wherein FIG. 4(a) shows a cross-sectional view thereof, and FIG. 4(b) is a front view thereof.

The depolarization means 23 is arranged in the projection unit (refer to FIG. 1) so that the light modulated by the spatial light modulation element transmits along the thickness direction thereof. As shown in FIG. 4(b), the depolarization means 23 has regions 23b where the abnormal refractive index is changed, and a region 23a where the abnormal refractive index is not changed. Furthermore, as shown in FIG. 4(a), the regions 23b where the abnormal refractive index is changed have different depths depending on their positions.

The depolarization means 23 is fabricated by masking a birefringent material substrate such as LiNbO3, and subjecting the substrate to a proton exchange process with an acid, and the proton-exchanged regions become the regions 23b where the abnormal refractive index is changed. The depolarization means 23 having the in-plane distribution of the birefringence property can also be fabricated by a method of forming a birefringent material film while changing the optical axis direction of the birefringent material, instead of the method of subjecting the birefringent material to the proton exchange process. The optical axis direction of the birefringent material can be changed by changing the direction along which the material is entered in the substrate when forming the birefringent material film.

Next, the operation and the functional effect of the second embodiment will be described.

When a light beam having a linear polarization direction being inclined with respect to the optical axis of the depolarization means 23 is incident on the depolarization means 23, different polarization states occur between the region 23b where the abnormal refractive index is changed and the region 23a where it is not changed, and thereby the linear polarization property of the light incident on the birefringent material is depolarized. Further, in the depolarization means 23, since the incident light becomes to have various polarization states depending on the depths of the regions 23b where the abnormal refractive index is changed, depolarization of the linear polarization property of the incident light is further promoted.

While the first embodiment adopts the depolarization means 21 which has a birefringent property having a thickness distribution and the second embodiment adopts the depolarization means 23 which has a birefringent property having an in-plane distribution instead of the depolarization means 21 of the first embodiment, the depolarization means are not restricted thereto, and any optical element may be adopted so long as it can perform depolarization for converting a linearly polarized light to a randomly polarized light.

Further, while in the above-mentioned embodiments a laser light source that emits a laser light having a linear polarization property is used, the laser light source may be one that emits a light having no linear polarization property, which light is obtained by combining light beams emitted from plural laser light sources with an optical fiber or the like. In this case, the light emitted from the light source is desired to be converted into a light having a linear polarization property before it is introduced to the modulation element.

### EMBODIMENT 3

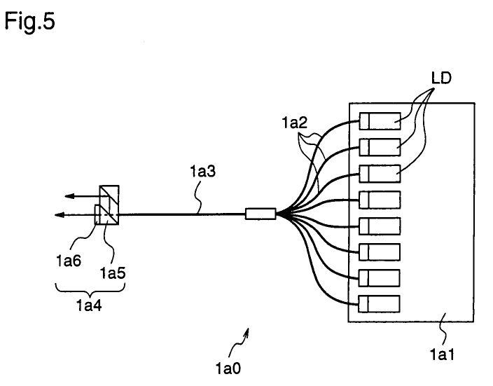

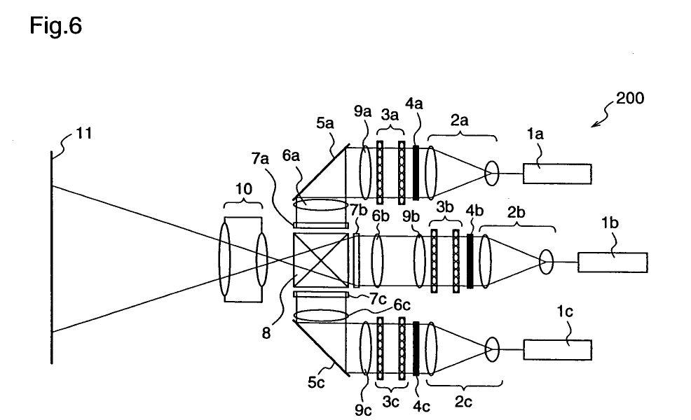

FIG. 5 is a diagram illustrating a two-dimensional image formation device according to a third embodiment of the present invention.

A two-dimensional image formation device 300 according to the third embodiment adopts a red laser light source 1a0 which combines lights emitted from plural laser light sources, and emits a light having no linear polarization property, instead of the red laser light source of the two-dimensional image formation device 100 according to the first embodiment. The light emitted from such red laser light source 1a0 is in the randomly polarized state, and such randomly polarized light restricts the type of the modulation means, and further, it is hard to deal with. Therefore, in this third embodiment, a polarization conversion element 1a4 for converting the randomly polarized light into a light having a linear polarization property is disposed at an emission end of a multimode fiber 1a3 so that the light having a linear polarization property is incident on the modulation means.

The red laser light source 1a0 comprises an LD chip array 1a1 including plural laser diodes (LD), plural optical fibers 1a2 which receive laser lights emitted from the respective laser diodes (LD) of the LD chip array 1a1, and a multimode fiber 1a3 which combines the lights emitted from the plural optical fibers 1a2 and outputs the combined light. This red laser light source 1a0 using the multimode fiber facilitates mechanism design such as arrangement of the light source, and enables separation of the light source from the image formation device.

The polarization conversion element 1a4 is disposed at the emission end of the multimode fiber 1a3, and comprises a polarization beam splitter 1a5 which separates the incident randomly polarized light into a S polarized light component and a P polarized light component, and a ½ wavelength plate 1a6 which converts the separated P polarized light component into an S polarized light to be output.

Next, the operation and the functional effect according to the third embodiment will be described.

In the two-dimensional image formation device according to the third embodiment, the laser lights having linear polarization properties which are emitted from the respective laser diodes of the LD chip array 1a1 are combined by the multimode fiber 1a3, and emitted as a randomly polarized light from the fiber. The randomly polarized light that is emitted from the red laser light source 1a0 and is incident on the polarization conversion element 1a4 is separated into the S polarized light component and the P polarized light component by the polarization beam splitter 1a5 . The separated S polarized light component is reflected in the splitter and outputted as a S polarized light, and the separated P polarized light component passes through the splitter and is converted into a S polarized light by the ½ wavelength plate 1a6. In this way, the randomly polarized light that is incident on the polarization conversion element 1a4 is converted into a light having a linear polarization property and then introduced into an optical system such as a modulation means. The operation other than mentioned above is identical to that of the first embodiment.

As described above, the two-dimensional image formation device according to the third embodiment is provided with the polarization conversion element 1a4 for converting a randomly polarized light into a light having a linear polarization property, and the linearly polarized light is incident on the modulation means. Therefore, it is possible to use a light source that emits a light having no linear polarization property, which is obtained by combining lights emitted from plural laser light sources using an optical fiber or the like.

While in this third embodiment a red laser light source for emitting a randomly polarized light is described, a green laser light source or a blue laser light source may be used as a light source which converts a light having no linear polarization property into a linearly polarized light.

Further, the two-dimensional image formation device according to the present invention is not restricted to the above-mentioned embodiments. For example, while in the respective embodiments a front projection type display which projects and displays an image on the forward screen 11 is described as the two-dimensional image formation device, the two-dimensional image formation device according to the present invention may be a rear projection type display using a transparent screen.

Further, while in the above-mentioned embodiments the rotation lenticular lens 14 is used as a means for changing the angle of the light incident on the modulation means, it may be a vibrational diffusion plate or a deflection element using a mirror such as a DMD. Further, the position where the deflection element is inserted is not restricted to the position before the incident plane of the light integrator, and the deflection element may be disposed in any position between the laser light source and the modulation means.

Further, while in the above-mentioned embodiments the two-dimensional image formation device is provided with the rod integrator 13 and the rotation lenticular lens, the two-dimensional image formation device may dispense with these elements. Also in this case, a reduction in speckle noise can be achieved.

Furthermore, while in the above-mentioned embodiments a modulation means utilizing a linear polarization property, such as a liquid crystal element, is described, the modulation means is not restricted thereto, and a means which performs modulation of an incident light by changing the direction in which the incident light is deflected, using a polygon mirror or the like, may be adopted.

Furthermore, while in the above-mentioned embodiments the lights of R, G, B colors are combined by the dichroic prism 8 and projected onto the display plane, the respective lights may be projected on the display plane without combining them. In this case, at least one of the lights of R, G, B may be subjected to depolarization of its linear polarization property after modulation.

Further, while in the above-mentioned embodiments the lights of R, G, B colors are modulated by the modulation means 7a to 7c, respectively, modulations of these R, G, B lights may be performed in time division by using a single modulation means, and the modulated R, G, B lights may be projected on the screen to be color-displayed.

### APPLICABILITY IN INDUSTRY

A two-dimensional image formation device according to the present invention can significantly reduce speckle noise when a two-dimensional image is displayed on a screen, and it is also applicable to cases where a two-dimensional image is displayed on a target other than the screen. For example, it is applicable to a semiconductor exposure device.

Further, the two-dimensional image formation device of the present invention is applicable to not only color image display but also monochromatic image display.

1. A two-dimensional image formation device having a laser light source, and a modulation means for modulating a light emitted from the laser light source, wherein:
the light modulated by the modulation means has a linear polarization property;
said device includes a depolarization means for depolarizing the linear polarization property of the light modulated by the modulation means, and a projection unit for projecting the modulated light onto an image display surface; and
said depolarization means is incorporated in the projection unit.

2. A two-dimensional image formation device as defined in claim 1 wherein an insertion position of the depolarization means satisfies a relationship of F/#<L<5f when a distance between the modulation means and the depolarization means is L, an F number of the projection unit is F/#, and a focal length of the projection unit on the modulation means side is f.

3. A two-dimensional image formation device as defined in claim 1 wherein:
said depolarization means includes a birefringent member comprising a birefringent material which is formed in a plate shape and has a thickness distribution, and
the light having a linear polarization property, which is modulated by the modulation means and outputted, is incident on the birefringent member with its polarization direction being inclined with respect to an optical axis of the birefringent member.

4. A two-dimensional image formation device as defined in claim 3 wherein:
said depolarization means comprises an optical element which is obtained by placing the birefringent member upon a plate-shaped thickness compensation member having a thickness distribution that compensates the thickness distribution of the birefringent member; and
the light having a linear polarization property, which is modulated by the modulation means and outputted, is incident on the optical element with its polarization direction being inclined with respect to the optical axis of the birefringent member.

5. A two-dimensional image formation device as defined in claim 3 wherein the birefringent property of the birefringent member has an in-plane distribution.

6. A two-dimensional image formation device as defined in claim 1 further including a deflection means for varying the angle of the light incident on the modulation means, said deflection means being disposed in a stage prior to the modulation means.

7. A two-dimensional image formation device as defined in claim 1 further including a light conversion means for converting a light in a randomly polarized state which is emitted from the light source into a light having a linear polarization property, said light conversion means being disposed in a stage prior to the modulation means.

8. A two-dimensional image formation device as defined in claim 4 wherein the birefringent property of the birefringent member has an in-plane distribution.
